(19) United States
(12) Patent Application Publication
(10) Pub. No.: US 2025/0136076 A1
(43) Pub. Date: May 1, 2025

(54) CONTROL ARRANGEMENT AND METHOD FOR DEACTIVATING AN ADAPTIVE CRUISE CONTROL SYSTEM OF A VEHICLE

(71) Applicant: Scania CV AB, Södertälje (SE)

(72) Inventors: Alexander Stamp, Huddinge (SE); David Karlsson, Linghem (SE)

(73) Assignee: Scania CV AB, Södertälje (SE)

(21) Appl. No.: 18/911,393

(22) Filed: Oct. 10, 2024

(30) Foreign Application Priority Data
Oct. 27, 2023 (SE) 2351224-7

(51) Int. Cl. B60T 8/72; B60Q 9/00; B60T 8/171; B60T 8/172

(52) U.S. Cl. CPC B60T 8/72; B60Q 9/00; B60T 8/171; B60T 8/172; B60T 2201/02; B60T 2250/04; B60T 2260/00

(57) ABSTRACT

A control arrangement and a method for deactivating an adaptive cruise control system. The method comprises, in response to a determination of risk of loss of functionality of the adaptive cruise control system while the host vehicle is decelerated by the adaptive cruise control system, determining whether the host vehicle may be braked by the service brake system; and, if so, activating a first failure mode during which the adaptive cruise control system is maintained active to decelerate the host vehicle until a deceleration demand is below a predetermined threshold. The method further comprises, when the deceleration demand is below the predetermined threshold, either ramping down the braking demanded by the adaptive cruise control system over a predetermined period of time and thereafter deactivating the adaptive cruise control system, or directly deactivating the adaptive cruise control system.

### TECHNICAL FIELD

The present disclosure relates in general to a method for deactivating an adaptive cruise control system of a host vehicle. The present disclosure further relates in general to a control arrangement configured to deactivate an adaptive cruise control system of a host vehicle.

The present disclosure further relates in general to a computer program and to a computer-readable medium. Moreover, the present disclosure relates in general to a vehicle.

### BACKGROUND

Vehicle speed control systems that automatically controls the travelling speed of a vehicle are common in modern vehicles. Examples of vehicle speed control systems include for example various types of cruise control systems.

One example of a cruise control system is a traditional cruise control that aims at maintaining a substantially constant vehicle speed, such as a set speed selected by a driver of the vehicle. Such a traditional cruise control may often be referred to as a constant speed cruise control. A constant speed cruise control is typically configured to maintain the vehicle speed within a narrow allowable speed range about the set speed and with the aim to maintain the vehicle speed at the set speed. A constant speed cruise control thus controls the vehicle with the aim to maintain the set speed set regardless of whether the vehicle is travelling uphill, downhill or on a horizontal running surface. This means that the vehicle may be accelerated over the crest of a hill, only to be braked on a subsequent downgrade to avoid a too high vehicle speed. This is an uneconomic way of running the vehicle, particularly in the case of heavy vehicles, since it may often unduly increase the energy consumption of the vehicle and hence the operating costs (such as fuel costs).

Another type of cruise control is a predictive cruise control, sometimes also referred to as a look-ahead cruise control. A predictive cruise control is a cruise control which uses information regarding characteristics of an upcoming road section, i.e. a road section ahead of the vehicle, and plans a driving strategy for the upcoming road section based on said information. The information regarding the upcoming road section may typically include at least topographic data and data relating to the curvature or the like of the upcoming road section, but could also for a more advanced predictive cruise control include information relating to for example traffic situation ahead of the vehicle and/or speed limits. The data may typically be derived from map data in combination with information regarding geographical positioning of the vehicle, and may in some situations also be supplemented with for example historical data relating to previous instances that the vehicle, or another vehicle, has travelled the upcoming road section. The predictive cruise control then controls the operation of the vehicle powertrain in accordance with the planned driving strategy as the vehicle travels the road section in question, which thereby results in the vehicle speed varying in accordance with a vehicle speed profile.

A predictive cruise control can save substantial amounts of energy compared to a constant speed cruise control. For example, in case the upcoming road section comprises an uphill followed by a downhill, the vehicle may be accelerated so as to, at the crest of the hill, have a speed which is lower than the set speed in situations where the vehicle speed may be increased during the downhill as a result of the gravitational force so as to reach the set speed. In order to take advantage of the positive effect obtainable by a predictive cruise control, the allowable speed range of the vehicle for such a cruise control is typically considerably broader than the allowable speed range of a constant speed cruise control.

Both a constant speed cruise controller and a predictive cruise controller may be supplemented by an adaptive cruise control function, if desired. The adaptive cruise control function is configured to automatically adjust the vehicle speed in order to maintain a safe distance (or desired distance) to other road users ahead of the vehicle. An adaptive cruise control function typically uses information from sensors arranged in or on the vehicle, such as radar, laser or image capturing devices (such as cameras), for the purpose of obtaining information regarding such other road users in front of the vehicle.

A cruise control system, such as a constant speed or predictive cruise control system, supplemented with an adaptive cruise control function may be referred to as an adaptive cruise control (ACC) system.

Many vehicle speed control systems, such as various cruise control systems, are configured to control vehicle speed not only by controlling positive acceleration of the vehicle but also by demanding braking of the vehicle from one or more brake systems of the vehicle when needed. In some cases, the vehicle speed control systems are configured to control vehicle speed through brake blending of available brake systems of the vehicle, the available brake systems including at least one auxiliary brake system and a service brake system. Examples of auxiliary brake systems that may be comprised in a vehicle include, but are not limited to, an exhaust brake system, a variable vane brake (VVB) system, a compression release brake (CRB) system, a regenerative brake system, and a retarder. In such cases, the vehicle speed control system may for example be configured to primarily demand braking from one or more auxiliary brake systems and supplement with demanding braking from the service brake system when needed or otherwise appropriate to do so.

Vehicle speed control systems are typically designed to assist the driver in the operation of vehicle. In case of loss in the full functionality of the vehicle speed control system, it may be necessary to automatically deactivate the vehicle speed control system for safety reasons, and thereby leave the responsibility of the operation of the vehicle to the driver of the vehicle. However, in case of an adaptive cruise control system, the deactivation of the adaptive cruise control system may, depending on the circumstances, risk leading to a hazardous situation. For example, in case the vehicle is driving in a downhill behind a road user having a lower travelling speed, deactivation of the adaptive cruise control system will inherently lead to the automatic braking of the vehicle, that the driver may rely on for having activated the adaptive cruise control system, being interrupted. Although automatic deactivation of the adaptive cruise control system is typically communicated to the driver, e.g., as an instrument cluster warning, the driver may not have sufficient time to react and take appropriate actions to avoid a collision.

WO 2007/078230 A1 discloses a system for controlling a foundation brake of a vehicle, said system comprising an adaptive cruise control (ACC) device and means to disengage the ACC device on detection of excessive use of the foundation brake. According to one embodiment of said system, the system further comprises means to determine whether the vehicle is at a safe distance behind any object in front of said vehicle and means to disengage the ACC device only if/when the distance between the vehicle and said object corresponds to or exceeds a predetermined safe distance.

### SUMMARY

The object of the present invention is to increase road safety in case of loss in functionality of an adaptive cruise control system.

The object is achieved by the subject-matter of the appended independent claim(s).

More specifically, the present disclosure provides a method, performed by a control arrangement, for deactivating an adaptive cruise control system of a host vehicle. The adaptive cruise control system is configured to maintain a safe distance to a target vehicle in front of the host vehicle through usage of one or more auxiliary brake systems and a service brake system of the host vehicle. The method comprises a step of, in response to a determination of risk of loss of functionality of the adaptive cruise control system while the host vehicle is, or is precited to be, decelerated by the adaptive cruise control system, determining whether the host vehicle may be braked by at least the service brake system. The method further comprises a step of, in case it is determined that the host vehicle may be braked by at least the service brake system, activating a first failure mode during which the adaptive cruise control system is maintained active to decelerate the host vehicle until a deceleration demand of the adaptive cruise control system is below a predetermined threshold or a difference in speed between the host vehicle and the target vehicle is below a predetermined limit. The method further comprises a step of, when the deceleration demand of the adaptive cruise control system is below the predetermined threshold, or the difference in speed between the host vehicle and the target vehicle is below the predetermined limit, either (i) ramping down the braking demanded by the adaptive cruise control system over a predetermined period of time and thereafter deactivating the adaptive cruise control system, or (ii) directly deactivating the adaptive cruise control system.

By means of the herein described method, the safety in operation of the host vehicle, and thereby also road safety in general, increases when the adaptive cruise control system is to be automatically deactivated due to risk for (or actual) loss of functionality thereof occurring while the host vehicle is, or is expected to be, decelerated by the adaptive cruise control system. More specifically, the present method utilizes (when appropriate to do so) a first failure mode during which the adaptive cruise control system is maintained active, and therefore able to decelerate the host vehicle by requesting/demanding braking power from one or more of the available brake systems of the host vehicle, until the driving situation is less dangerous. This means that the transfer of the responsibility for controlling vehicle speed of the host vehicle to the driver will be delayed until it is safer to do so. This in turn allows more time for the driver to react and take appropriate action, if needed. Thus, deactivating the adaptive cruise control system when the host vehicle is in a less critical driving situation also reduces the stress that the driver may experience when the adaptive cruise control system is automatically deactivated due to risk for, or actual, loss in functionality thereof.

According to one aspect, the above mentioned determination of risk of loss of functionality of the adaptive cruise control system may be based on an assessment that the host vehicle cannot be positively accelerated by the adaptive cruise control system. If the reason for risk of loss of functionality is a fault related to something affecting the ability of the adaptive cruise control system to positively accelerate the host vehicle, the adaptive cruise control system may still be able to control at least some of the available braking systems of the host vehicle for the purpose of decelerating the host vehicle. Even if one auxiliary brake system would be (directly or indirectly) affected by the same fault affecting the ability to positively accelerate the host vehicle, the host vehicle may still be braked by another auxiliary brake system and/or at least the service brake system. In such instances, the usage of the first failure mode before the step of deactivating the adaptive cruise control system may considerably increase the safety in the operation of the host vehicle before transferring the responsibility of the control of vehicle speed to the driver.

The method may further comprise a step of, when deactivating the adaptive cruise control system, generating a warning message and/or signal adapted to inform a driver of the host vehicle of deactivation of the adaptive cruise control system. Thereby, the driver is informed of the deactivation of the adaptive cruise control system and thus also that the vehicle speed no longer is automatically controlled. Generating said warning message and/or signal only when the first failure mode has been terminated, i.e. when the step of deactivation of the adaptive cruise control system occurs, may reduce the possible stress that the driver may experience as the host vehicle is then in a safer driving situation. Although it would alternatively be possible to generate said warning message and/or signal while the adaptive cruise control system is in the first failure mode, or when activating said first failure mode, this may risk leading to confusion and therefore a more stressful situation for the driver not necessarily knowing how the vehicle speed is controlled and if he/she is expected to take action.

Moreover, the method may further comprise a step of, in response to a determination that information pertaining to the target vehicle is lost by the adaptive cruise control system, activating a second failure mode during which braking demanded by the adaptive cruise control system is ramped down over a predetermined period of time, and thereafter a step of deactivating the adaptive cruise control system. The second failure mode gives the driver more time to react and take appropriate action when the loss in functionality is due to loss of information pertaining to the target vehicle, and therefore increases road safety compared to, for example, if the adaptive cruise control system would be directly deactivated.

The method may further comprise, when the second failure mode is activated, a step of generating a warning message and/or signal adapted to inform a driver of the host vehicle of upcoming deactivation of the adaptive cruise control system. This inter alia gives the driver slightly more time to react and take appropriate action, and thereby increases road safety.

The step of determining whether the host vehicle may be braked by at least the service brake system may comprise determining whether the temperature of the service brake system is below a predefined temperature threshold. Such a predefined temperature may be offset from a critical temperature at which overheating of the service brake system may occur. Thus, by considering whether the temperature of the service brake system is below the predefined temperature threshold, it may for example be ensured that a driver may still brake the host vehicle using the service brake system in case the adaptive cruise control system should need to be deactivated or the braking power requested therefrom be ramped down.

The method may further comprise a step of, in case it is determined that the host vehicle cannot be braked by the service brake system, deactivating the adaptive cruise control system. This in turn further increases the road safety for giving the driver the best possible opportunity, given the circumstances, to brake the host vehicle.

The present disclosure further relates to a computer program comprising instructions which, when executed by a computer, cause the computer to carry out the method as described above.

The present disclosure further relates to a computer-readable medium comprising instructions which, when executed by a computer, cause the computer to carry out the method as described above.

The present disclosure also relates to a control arrangement configured to deactivate an adaptive cruise control system of a host vehicle, said adaptive cruise control system being configured to maintain a safe distance to a target vehicle in front of the host vehicle through usage of one or more auxiliary brake systems and a service brake system of the host vehicle. The control arrangement is configured to, in response to a determination of risk of loss of functionality of the adaptive cruise control system while the host vehicle is, or is precited to be, decelerated by the adaptive cruise control system, determine whether the host vehicle may be braked by at least the service brake system. The control arrangement is further configured to, when having determined that the host vehicle may be braked by at least the service brake system, activate a first failure mode during which the adaptive cruise control system is maintained active to decelerate the host vehicle until a deceleration demand of the adaptive cruise control system is below a predetermined threshold or a difference in speed between the host vehicle and the target vehicle is below a predetermined limit. Moreover, the control arrangement is configured to, when the deceleration demand of the adaptive cruise control system is below the predetermined threshold, or the difference in speed between the host vehicle and the target vehicle is below the predetermined limit, either ramp down the braking demanded by the adaptive cruise control system over a predetermined period of time and thereafter deactivate the adaptive cruise control system, or directly deactivate the adaptive cruise control system.

The control arrangement provides the same advantages as described above with reference to the corresponding method for deactivating an adaptive cruise control system.

The control arrangement may for example be configured to determine said risk of loss of functionality of the adaptive cruise control system based on an assessment of whether the host vehicle may be positively accelerated by the adaptive cruise control system.

The control arrangement may further be configured to, in response to a determination that information pertaining to the target vehicle is lost by the adaptive cruise control system, activate a second failure mode during which braking demanded by the adaptive cruise control system is ramped down over a predetermined period of time, and thereafter deactivate the adaptive cruise control system.

The present disclosure also relates to a vehicle comprising the control arrangement described above. The vehicle may be a land-based heavy vehicle, such as a bus or a truck. The vehicle may for example be a fully electric vehicle, a hybrid vehicle, or a vehicle driven solely by a combustion engine. Furthermore, the vehicle may be a vehicle configured to a driven fully or in part by a driver. Such a driver may be present onboard the vehicle, or be remote from the vehicle (such as at a remote control center or the like).

### BRIEF DESCRIPTION OF DRAWINGS

FIG. 1 schematically illustrates a side view of an example of a vehicle,

FIG. 2 illustrates an example of a traffic situation where a target vehicle is in front of a host vehicle,

FIG. 3 represents a flowchart schematically illustrating one exemplifying embodiment of the herein described method for deactivating an adaptive cruise control system of a host vehicle,

FIG. 4 schematically illustrates an exemplifying embodiment of a device that may comprise, consist of, or be comprised in the herein described control arrangement configured to deactivate an adaptive cruise control system of a host vehicle.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

An adaptive cruise control system is in the present disclosure considered to mean a cruise control system (such as a predictive cruise control system or a constant speed cruise control system) supplemented with an adaptive cruise control function, said adaptive cruise control function being configured to automatically adjust the vehicle speed of a host vehicle in order to maintain a safe distance to a target vehicle. It is well known in the art that what is regarded as a safe distance may vary depending on the circumstances (including configuration of the host vehicle and available braking power, vehicle speed, weather conditions etc.) and may constitute either an actual distance (such as in meters) or a time distance (such as in seconds).

In the present disclosure, the term “host vehicle” should be considered to mean a vehicle whose vehicle speed is, or may be, controlled by the herein described adaptive cruise control system.

Furthermore, the term “target vehicle” is intended to mean a vehicle, different from the host vehicle, and present in front of the host vehicle as seen in a current travelling direction of the host vehicle.

Moreover, the terms “travelling speed” of a vehicle and “vehicle speed” are in the present disclosure used interchangeably, and should thus be considered to have the same meaning.

The present disclosure relates to a method for deactivating an adaptive cruise control system of a host vehicle in case of risk of loss of functionality of the adaptive cruise control system. The term “risk for loss of functionality” is herein intended to encompass both an actual loss of functionality as well as an expected, future, loss of functionality of the adaptive cruise control system. A loss of functionality of an adaptive cruise control system may occur due to a number of different reasons/faults, including one or more faults affecting the ability of the adaptive cruise control system to positively accelerate the host vehicle, one or more faults affecting the ability of the adaptive cruise control system to decelerate the host vehicle, and/or one or more faults leading to inability to obtain information necessary for the purpose of determining different control factors. Examples of situations where the adaptive cruise control system is unable to positively accelerate the host vehicle may for example be faults in the hardware of, or in the control of, a propulsion unit, a gearbox, or any other constituent component of the powertrain of the host vehicle. Examples of situations where the adaptive cruise control system may be unable to decelerate the host vehicle may for example include faults in, or in the control of, one or more brake systems of the host vehicle. Moreover, situations where the reason(s) leading to loss of functionality of the adaptive cruise control system are related to inability to obtain necessary information may include for example inability to derive information pertaining to a target vehicle, inability to determine current mass of host vehicle, inability to determine road characteristics, etc. Irrespectively of the reason for loss of functionality of the adaptive cruise control system, it is in general advisable to deactivate the adaptive cruise control system if such a loss may occur. However, in accordance with the present method, the manner in which the adaptive cruise control system is deactivated varies depending on the circumstances. This increases the safety in the operation of the host vehicle when the adaptive cruise control system is to be automatically deactivated due to risk for loss of functionality thereof and the responsibility for the operation of the host vehicle should be transferred in its entirety to the driver.

The adaptive cruise control system, which is to be deactivated in accordance with the present method, is configured to (when activated) control the travelling speed of the host vehicle to maintain a target speed except when such a target speed is too high to ensure a safe distance to a possible target vehicle present in front of the host vehicle. The target speed may for example be, but is not limited to, a set speed selected by a driver of the vehicle, or a reference speed selected by the adaptive cruise control system in consideration of such a set speed selected by the driver. It should here be noted that the target speed may, in some cases, vary over time and be dependent on e.g., characteristics of an upcoming road section. The control of the travelling speed of the host vehicle to maintain a target speed may be considered to be performed in accordance with a target speed cruise control function of the adaptive cruise control system. When the target speed is too high to ensure a safe distance to a target vehicle, the adaptive cruise control system is configured to control the travelling speed of the host vehicle so as to maintain a safe distance to the target vehicle through usage of one or more auxiliary brake systems and a service brake system of the host vehicle. The control of the travelling speed of the host vehicle to maintain a safe distance to a target vehicle may be considered to be performed in accordance with an adaptive cruise control function of the adaptive cruise control system. More specifically, the adaptive cruise control system may be configured to control vehicle speed through brake blending of available brake systems of the host vehicle for the purpose of ensuring sufficient braking power to meet a deceleration demand ensuring a safe distance to the target vehicle. Examples of auxiliary brake systems that may be comprised in the host vehicle include, but are not limited to, an exhaust brake system, a variable vane brake (VVB) system, a compression release brake (CRB) system, a regenerative brake system, and/or a retarder. It should here be noted that the adaptive cruise control function of the adaptive cruise control system may also be configured to positively accelerate the vehicle when needed in order to maintain the distance to the target vehicle within a desired distance interval, the lower end value of said distance interval corresponding to the above described safe distance to the target vehicle.

The herein described method for deactivating an adaptive cruise control (ACC) system of a host vehicle comprises a step of, in response to a determination of risk for loss of functionality of the adaptive cruise control system while the host vehicle is, or is precited to be, decelerated by the adaptive cruise control system, determining whether the host vehicle may be braked by at least the service brake system. The host vehicle is predicted to be decelerated by the adaptive cruise control system when a target vehicle has been identified and the adaptive cruise control system has determined that the host vehicle needs to be decelerated to ensure a safe distance to the target vehicle, but has not yet demanded braking from available braking systems of the vehicle.

According to one alternative, said determination of risk for loss of functionality of the adaptive cruise control system may be due to at least one fault affecting the ability of the adaptive cruise control to positively accelerate the host vehicle. In other words, the determination of risk of loss of functionality of the adaptive cruise control system may be based on an assessment that the host vehicle cannot be positively accelerated by the adaptive cruise control system. The fault affecting the ability of the adaptive cruise control to positively accelerate the host vehicle may for example be in hardware of the powertrain (e.g., gearbox stuck in neutral or the like), or in the control of the powertrain of the host vehicle. According to yet one alternative, the fault may be that the adaptive cruise control system is unable to determine a positive acceleration demand to reach and/or maintain a target speed, for example due to loss of necessary information therefore. The herein described method for deactivating the adaptive cruise control system is however not limited to the alternative of the determination of risk for loss of functionality of the adaptive cruise control system being due to a fault affecting the ability of the adaptive cruise control to positively accelerate the host vehicle.

The method further comprises a step of, when/if it is determined that the host vehicle may be braked by at least the service brake system, activating a first failure mode of the adaptive cruise control system. When being in the first failure mode, the adaptive cruise control system is maintained active to decelerate the host vehicle and is therefore controlling the vehicle speed of the host vehicle in accordance with the adaptive cruise control function in the same way as it would have in case there would be no risk for loss of functionality of the adaptive cruise control system. However, in contrast with the normal control mode of the adaptive cruise control system, the first failure mode is a control mode which is performed pending an upcoming automatic deactivation of the adaptive cruise control system, said automatic deactivation being triggered by the determination of a risk of loss of functionality. According to a first alternative of the first failure mode, the adaptive cruise control system is maintained active to decelerate the host vehicle until a deceleration demand of the adaptive cruise control system is below a predetermined threshold. If so, the first failure mode is automatically terminated when the deceleration demand of the adaptive cruise control system is below the predetermined threshold. According to a second alternative of the first failure mode, the adaptive cruise control system is maintained active to decelerate the host vehicle until a difference in speed between the host vehicle and the target vehicle, i.e. the relative speed between the host and target vehicles, is below a predetermined limit. If so, the first failure mode is automatically terminated when the difference in speed between the host vehicle and the target vehicle, is below the predetermined limit. It should here be noted that the first alternative of the first failure mode is preferred since the deceleration demand is typically a more relevant parameter to use when controlling the vehicle speed of the host vehicle compared to the simpler version of merely considering the relative speed.

The method further comprises a step of, when the first failure mode is terminated, deactivating the adaptive cruise control system. Said deactivation of the adaptive cruise control system, when the first failure mode has been terminated, may optionally be preceded by a step of ramping down the braking demanded by the adaptive cruise control system over a predetermined period of time, if desired. For example, the braking demanded by the adaptive cruise control system may be ramped down to zero over a period of maximally five seconds or maximally 3 seconds.

Deactivation of the adaptive cruise control system leads to all control functions thereof being deactivated, whereby the vehicle speed of the host vehicle will no longer be automatically controlled. In other words, deactivation of the adaptive cruise control system not only means that the host vehicle will not be automatically braked but also means that the host vehicle will not be automatically positively accelerated in situations where it would otherwise be possible to do so, such as if the traffic in front of the host vehicle clears.

The method may suitably also comprise a step of, when deactivating the adaptive cruise control system, generating a warning message and/or signal adapted to inform a driver of the host vehicle of deactivation of the adaptive cruise control system. Said warning message and/or signal may be communicated to the driver in accordance with any previously known methods therefore, for example as an audible, a visual and/or a haptic warning. Thereby, the driver will be informed that the adaptive cruise control system is automatically deactivated and that the responsibility for controlling the vehicle speed therefore now rests with the driver.

The method may further comprise a step of, in response to a determination that information pertaining to the target vehicle is lost by the adaptive cruise control system, activating a second failure mode. When in the second failure mode, the adaptive cruise control system is configured to ramp down the braking demanded by the adaptive cruise control system over a predetermined period of time, such as during maximally 5 seconds or during maximally 3 seconds. Suitably, the braking demanded by the adaptive cruise control system may be ramped down to zero, or close thereto. The second failure mode is automatically terminated when said ramping down has been completed. As soon as the second failure mode is terminated, the method comprises a step of deactivating the adaptive cruise control system.

In case of the second failure mode, the method may suitably further comprise a step of generating a warning message and/or signal adapted to inform a driver of the host vehicle of an upcoming deactivation of the adaptive cruise control system, this being generated already when activating the second failure mode. Thus, in contrast to the case in which the first failure mode, the warning message and/or signal is generated in advance of the actual deactivation of the adaptive cruise control system. The reason for generating the warning message and/or signal earlier in the case of the second failure mode is that there is a higher likelihood that the driver needs to take immediate action to avoid a hazardous situation compared to the case of the first failure mode, which ensures that host vehicle has been sufficiently decelerated before deactivating the adaptive cruise control system and thereby safely transferring the responsibility to the driver. It may however also be possible to generate the warning message and/or signal only when deactivating the adaptive cruise control system also in the case of the second failure mode, although this is less preferred for the reasons already mentioned above.

As an alternative to activating the above described second failure mode, the method may in some cases comprise a step of, in response to a determination that information pertaining to the target vehicle is lost by the adaptive cruise control system, activating a third failure mode. When in the third failure mode, the adaptive cruise control system requests braking from one or more of the available braking systems of the host vehicle (i.e. one or more auxiliary brake and/or the service brake system) to reach the latest known vehicle speed of the target vehicle within a predetermined period of time, such as within maximally 5 seconds, and thereafter ramping off the braking demanded in the same way as described above with regard to the second failure mode. It should however be noted that the third failure mode presumes that said “latest known vehicle speed of the target vehicle” has been stored at the time at which information pertaining to the target vehicle is lost by the adaptive cruise control system such that it can be retrieved for performing the third failure mode.

In case of the third failure mode, the method may suitably also comprise a step of generating a warning message and/or signal adapted to inform a driver of the host vehicle of an upcoming deactivation of the adaptive cruise control system, this being generated already when activating the third failure mode.

As previously mentioned, the herein described method comprises a step of determining whether the host vehicle may be braked by at least the service brake system. Said step may comprise determining whether the current temperature of the service brake system is below a predefined temperature threshold. The current temperature of the service brake system may be a predicted temperature, or a measured temperature, without departing from the present disclosure. Moreover, the predefined temperature threshold may typically be offset from (and lower than) a critical temperature at which overheating of the service brake system may occur. The predefined temperature threshold may for example be selected to be at least 100° C., preferably at least 200° C., below the critical temperature of the service brake system. Overheating of the service brake system may lead to thermal damage and/or brake fading, which means that the host vehicle would not be able to be braked by the service brake system. Since the responsibility for controlling the vehicle speed is transferred to the driver by the deactivation of the adaptive cruise control system, it is important to ensure that this is not performed when the service brake system has reached such a high temperature that it may be difficult for the driver brake the vehicle. Therefore, the predefined temperature threshold is important to consider.

In case it is determined that the host vehicle cannot be braked by the service brake system, for example due to the temperature of the service brake system being above the predefined temperature threshold described above, the herein described method suitably comprises a step of deactivating the adaptive cruise control system essentially immediately. The reason therefore is to minimize any further increase in temperature of the service brake system caused by the adaptive cruise control system requesting braking power therefrom, which would put the driver in an even more dangerous situation when taking over the responsibility for the control of the vehicle speed.

The performance of the herein described method for deactivating an adaptive cruise control system of a host vehicle may be governed by programmed instructions. These programmed instructions may take the form of a computer program which, when executed by a computer, cause the computer to effect desired forms of control action. Such a computer may for example be comprised in the control arrangement as described herein. A computer is in the present disclosure considered to mean any hardware or hardware/firmware device implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, an application-specific integrated circuit, or any other device capable of electronically performing operations in a defined manner.

The above described programmed instructions, which may take the form of a computer program, may be stored on a computer-readable medium. Hence, the present disclosure also relates to a computer-readable medium storing instructions, which when executed by computer, cause the computer to carry out the herein described method for deactivating an adaptive cruise control system of a host vehicle. The computer-readable medium may be a non-transitory computer-readable medium, such as a tangible electronic, magnetic, optical, infrared, electromagnetic, and/or semiconductor system, apparatus, and/or device.

The present disclosure further relates to a control arrangement configured to deactivate an adaptive cruise control system of a host vehicle. The control arrangement may be configured to perform any one of the steps of the method for deactivating an adaptive cruise control system of a host vehicle as described above.

More specifically, in accordance with the present disclosure, a control arrangement configured to deactivate an adaptive cruise control system of a host vehicle is provided, wherein said adaptive cruise control system is configured to maintain a safe distance to a target vehicle in front of the host vehicle through usage of one or more auxiliary brake systems and a service brake system of the host vehicle. The control arrangement is configured to, in response to a determination of risk of loss of functionality of the adaptive cruise control system while the host vehicle is, or is precited to be, decelerated by the adaptive cruise control system, determine whether the host vehicle may be braked by at least the service brake system. The control arrangement is further configured to, when having determined that the host vehicle may be braked by at least the service brake system, activate a first failure mode during which the adaptive cruise control system is maintained active to decelerate the host vehicle until a deceleration demand of the adaptive cruise control system is below a predetermined threshold or a difference in speed between the host vehicle and the target vehicle is below a predetermined limit. The control arrangement is further configured to, when the deceleration demand of the adaptive cruise control system is below the predetermined threshold, or the difference in speed between the host vehicle and the target vehicle is below the predetermined limit, either ramp down the braking demanded by the adaptive cruise control system over a predetermined period of time and thereafter deactivate the adaptive cruise control system, or directly deactivate the adaptive cruise control system.

The control arrangement may suitably further be configured to determine said risk of loss of functionality of the adaptive cruise control system based on an assessment that the host vehicle cannot be positively accelerated by the adaptive cruise control system.

The control arrangement may further be configured to, in response to a determination that information pertaining to the target vehicle is lost by the adaptive cruise control system, activate a second failure mode during which braking demanded by the adaptive cruise control system is ramped down over a predetermined period of time, and thereafter deactivate the adaptive cruise control system.

Moreover, the control arrangement may also be configured to, when/if it is determined that the host vehicle cannot be braked by the service brake system, deactivate the adaptive cruise control system.

The control arrangement may comprise one or more control units. In case of the control arrangement comprising a plurality of control units, each control unit may be configured to control a certain function/step or a certain function/step may be divided between more than one control units. The control arrangement may be a control arrangement of an adaptive cruise control system of a vehicle. Alternatively, the control arrangement may be any other control arrangement of the vehicle but configured to communicate with the adaptive cruise control system for the purpose of performing the herein described method.

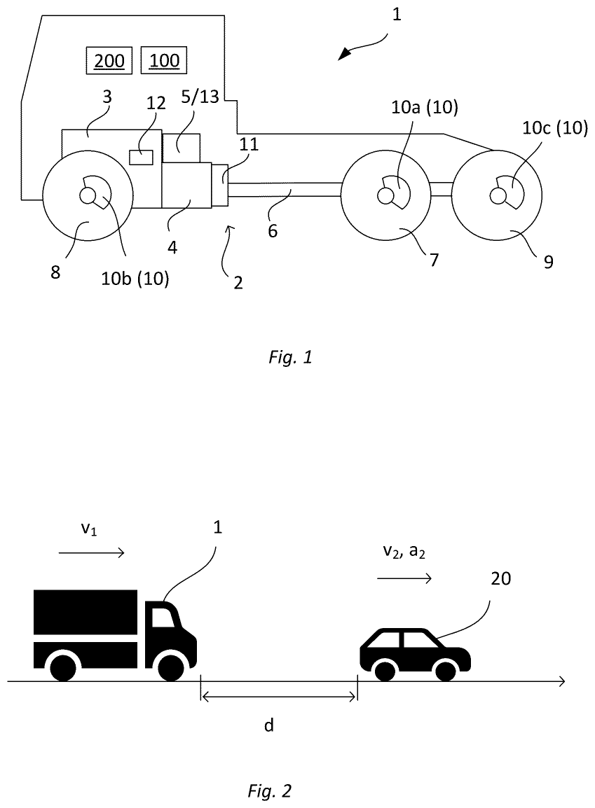

FIG. 1 schematically illustrates a side view of an example of a vehicle 1, here illustrated as a truck. The exemplified vehicle 1 comprises a powertrain 2 comprising at least one propulsion unit, here illustrated as a combustion engine 3, and a gearbox 4. The combustion engine 3 may be connected to the gearbox 4 via a clutch (not shown). The gearbox 4 may be connected to the driving wheels 7 of the vehicle 1 via an output shaft 6 of the gearbox 4. The vehicle further comprises front wheels 8 and optionally also tag axle wheels 9. It should be noted that although FIG. 1 illustrates a vehicle 1 comprising driving wheels 7 arranged in front of tag axle wheels 9, and thus inherently also a drive axle in front of the tag axle, a possible tag axle may alternatively or additionally be arranged in front of the drive axle in case the vehicle comprises such a tag axle. The vehicle 1 may, if desired, comprise a plurality of drive axles with associated driving wheels 7.

As previously mentioned, the present disclosure is not limited to a vehicle driven solely by a combustion engine. The vehicle 1 may additionally, or alternatively, comprise one or more electrical machines 5 (only one shown in the figure) serving as a propulsion unit.

The vehicle 1 comprises a service brake system 10. The service brake system may comprise service brakes 10a arranged at the respective driving wheels 7, service brakes 10b arranged at the front wheels 8 and/or service brakes 10c arranged at any other wheel of the vehicle 1 as shown in the figure.

The vehicle 1 further comprises one or more auxiliary brake systems. For example, the vehicle 1 may comprise an auxiliary brake system in the form of a retarder 11. Such a retarder 11 may for example be connected to an output shaft of the gearbox 4 as illustrated in the figure. Alternatively, the retarder may be connected to a shaft of the combustion engine 3. Additionally, or alternatively, the vehicle 1 may comprise an auxiliary brake system in the form of an engine brake system 12. The engine brake system 12 may for example be a compression release brake system, an exhaust brake system, or a variable vane brake system. Furthermore, when present, the electrical machine 5 may also serve as an auxiliary brake system in the form of a regenerative brake system 13. When serving as a regenerative brake system 13, the electrical machine 5 is operated as generator for the purpose of converting kinetic energy of the vehicle to electrical energy which for example may be used to charge an energy storage device (not shown) of the vehicle. The energy stored in the energy storage device may thereafter be used for the purpose of driving the electrical machine when the electrical machine is operated as a propulsion unit of the vehicle.

The vehicle may further comprise an adaptive cruise control system 200. The adaptive cruise control system 200 is configured to, when activated, control the travelling speed of the vehicle 1. For said purpose, the adaptive cruise control system 200 may be configured to control the propulsion unit(s), i.e. the combustion engine 13 and/or electrical machine 5, the gearbox 4 as well as the brake systems, i.e. the service brake system 10 and each of the auxiliary brake systems described above. When the vehicle 1 comprises the adaptive cruise control system 200, it is considered to constitute a “host vehicle” in accordance with the present disclosure.

The vehicle 1 may further comprise the herein described control arrangement 100 configured to deactivate the adaptive cruise control system 200. The control arrangement 100 may be a part of the adaptive cruise control system 200. Alternatively, the control arrangement 100 may be separate from the adaptive cruise control system 200, but configured to communicate therewith at least for the purpose of performing the herein described method for deactivating the adaptive cruise control system 200.

FIG. 2 illustrates an example of a traffic situation where a target vehicle 20 is present in front of the host vehicle 1 whose travelling speed is controlled by an adaptive cruise control system. The host vehicle 1 has a first vehicle speed v₁. The target vehicle 20 has a second vehicle speed v₂ and an acceleration a₂ (wherein said acceleration may be a positive acceleration or a negative acceleration, i.e. deceleration, depending on the circumstances). The host vehicle 1 is present at a distance d behind the target vehicle 20, said distance sometimes being referred to as a “trailing distance” in the art.

The adaptive cruise control system may suitably be configured to control the vehicle speed of the host vehicle 1 for maintaining a safe distance to the target vehicle 20 based on a deceleration demand. Said deceleration demand is in turn dependent of relative speed, i.e. (v₁-v₂), distance d, and the target vehicle acceleration a₂.

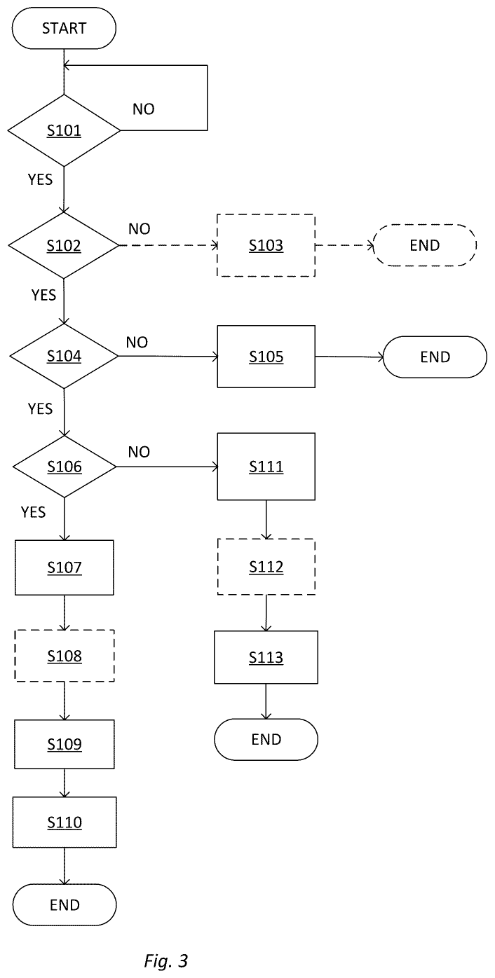

FIG. 3 represents a flowchart schematically illustrating one exemplifying embodiment of the herein described method for deactivating an adaptive cruise control system of a host vehicle. In the figure, optional steps of the exemplifying embodiment are shown by dashed lines. In view of the method being a method for deactivating an adaptive cruise control system, the adaptive cruise control system is active, i.e. in an operational mode, at the start of the method. The method may for example be initiated as soon as the adaptive cruise control systems is activated.

The method according to the exemplifying embodiment comprises a first step S101 of determining whether there is a risk for loss of functionality of the adaptive cruise control system. In case it is determined in step S101 that there is no risk for loss of (full) functionality of the adaptive cruise control system, the method is reverted to start. However, in case it is determined that there is a risk for loss of functionality of the adaptive cruise control system, the method proceeds to the subsequent step(s).

The method according to the exemplifying embodiment further comprises a step S102 of determining whether the host vehicle is, or is predicted to be, decelerated by the adaptive cruise control system. In other words, step S102 comprises determining whether the host vehicle is currently braked by the adaptive cruise control system or at least is predicted to be braked by the adaptive cruise control system within short. In case it is determined in step S102 that the host vehicle is neither (currently) decelerated by the adaptive cruise control system, nor predicted to be decelerated by the adaptive cruise control system, the method may suitably proceed to a step S103 of deactivating the adaptive cruise control system. Alternatively, the method may, instead of proceeding to step S103, be reverted to start. If present, step S103 may suitably further comprise generating a warning message and/or signal adapted to inform a driver of the host vehicle of deactivation of the adaptive cruise control system.

In case it is determined in step S102 that the host vehicle is, or is predicted to be, decelerated by the adaptive cruise control system, the method proceeds to a step S104 of determining whether the host vehicle may be braked by at least the service brake system. In other words, step S104 comprises determining whether the service brake system is available for braking the host vehicle, i.e. that the service brake system has sufficient functionality to brake the host vehicle. The determination of whether the vehicle may be braked by the service brake system in step may for example be based on a measured, or estimated, temperature of the service brake system. For example, in case the measured or estimated temperature of the service brake system is determined to be above a predefined temperature threshold (said threshold being offset from, and lower than, a critical temperature of the service brake system at which brake fading or thermal damage may occur), it may be determined that the host vehicle cannot be braked by the service brake system. According to a more advanced version of the herein described method, step S104 may comprise determining whether the host vehicle may be sufficiently braked by the service brake system to meet a deceleration demand of the adaptive cruise control system, at least when used in combination with the one or more auxiliary brake systems taking into account the currently available braking power therefrom. However, in a simpler version of the method, step S104 simply comprises determining whether the service brake system is expected to be functional, and thereby available for braking of the host vehicle.

In case it is determined in step S104 that the host vehicle cannot be braked by at least the service brake system, the method according to the exemplifying embodiment proceeds to a step S105 of deactivating the adaptive cruise control system. Step S105 may suitably further comprise generating a warning message and/or signal adapted to inform a driver of the host vehicle of deactivation of the adaptive cruise control system. After step S105, the method according to the exemplifying embodiment is ended.

The method according to the exemplifying embodiment further comprises, in case it is determined in step S104 that the host vehicle may be braked by at least the service brake system, a step S106 of determining whether the adaptive cruise control system is able to determine a deceleration demand, i.e., the deceleration needed in order to maintain a safe distance to a target vehicle. Step S106 may alternatively be described as a step of determining whether it is possible to control the adaptive cruise control system in accordance with a first failure mode, said first failure mode being described further below. More specifically, step S106 may comprise (or consist of) determining whether information pertaining to a target vehicle is, or at least may be, derived by the adaptive cruise control system such that the adaptive cruise control system is able to determine a deceleration demand needed to maintain a safe distance to a target vehicle. Examples of situations when information pertaining to a target vehicle cannot be derived by the adaptive cruise control system include failure of the sensor(s) configured to derive information relating to the target vehicle (such as radar, laser and/or camera) as well as software error(s), such as failure to predict travelling speed of target vehicle or the like.

It should here be noted that although step S104 is illustrated in the figure as being performed prior to step S106, these steps may be performed in any order or in parallel without departing from the herein described method for deactivating an adaptive cruise control system.

In case it is determined in step S106 that the adaptive cruise control system is able to determine a deceleration demand (and thereby that the adaptive cruise control system may be controlled in accordance with the first failure mode), the method according to the exemplifying embodiment proceeds to a step S107 of activating the first failure mode. When the adaptive cruise control is controlled in accordance with the first failure mode, the adaptive cruise control system is maintained active so as to decelerate the host vehicle until a deceleration demand of the adaptive cruise control system is below a predetermined threshold. In other words, the first failure mode comprises maintaining the adaptive cruise control system active and operating in accordance with its intended function, and is automatically terminated when the deceleration demand of the adaptive cruise control system falls below the predetermined threshold. Maintaining the adaptive cruise control system active, despite that there may be a risk for loss of functionality thereof, allows for a increasing the safety in operation of the host vehicle before turning over the responsibility for the control of vehicle speed to the driver of the host vehicle.

After step S107, i.e. when the deceleration demand of the adaptive cruise control system is below the predetermined threshold, the method may optionally comprise a step S108 of ramping down the braking demanded by the adaptive cruise control system over a predetermined period of time. Said predetermined period of time may be relatively short, for example at most 5 seconds or even at most 3 seconds.

Furthermore, after step S107 (and, if present, step S108) the method comprises a step S109 of deactivating the adaptive cruise control system. Deactivation of the adaptive cruise control system means that the travelling speed of the host vehicle will no longer be automatically controlled by the adaptive cruise control system. Instead, the responsibility for the control of travelling speed of the host vehicle is left to the driver of the host vehicle.

The method according to the exemplifying embodiment further comprises a step S110 of generating a warning message and/or signal adapted to inform a driver of the host vehicle of deactivation of the adaptive cruise control system. Although step S110 is shown in the figure as being performed after step S109, it may suitably be performed simultaneously with step S109. In case step S108 is present, step S110 may alternatively be performed in parallel with step S108. In other words, step S110 may be performed as soon as the deceleration demand of the adaptive cruise control system is below the predetermined threshold. When the adaptive cruise control system has been deactivated, the method may be ended as shown in the figure.

In case it is determined in step S106 that the adaptive cruise control system is unable to determine a deceleration demand (and thereby that the adaptive cruise control system cannot be controlled in accordance with the first failure mode), for example due to loss of information pertaining to a target vehicle, the method according to the exemplifying embodiment comprises a step S111 of activating a second failure mode. When the adaptive cruise control is controlled in accordance with the second failure mode, the braking demanded by the adaptive cruise control system is ramped down over a predetermined period of time (similar to the optional step S108). The braking demanded by the adaptive cruise control system may suitably be ramped down to zero. The predetermined period of time may for example be selected to allow a driver to realize that the adaptive cruise control system is about to be deactivated, and may typically be relatively short. The predetermined period of time may for example be maximally 5 seconds, but is not limited thereto.

The method according to the exemplifying embodiment may further comprise a step S112, which may suitably be performed substantially in parallel with step S111, of generating a warning message and/or signal adapted to inform a driver of the host vehicle of upcoming deactivation of the adaptive cruise control system. Alternatively, or additionally, the method may comprise a step of generating such a warning message and/or signal when the adaptive cruise control system is actually deactivated.

After step S111, and, if present, step S112, the method according to the exemplifying embodiment comprises a step S113 of deactivating the adaptive cruise control system. In other words, the method comprises deactivating the adaptive cruise control system when the second failure mode has ended. Thereafter, the method may be ended.

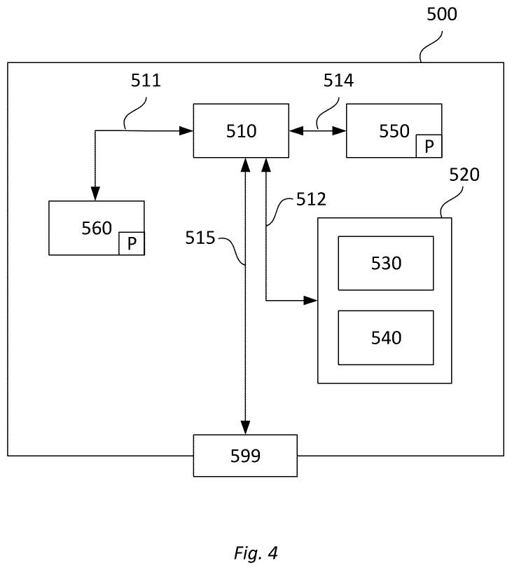

FIG. 4 schematically illustrates an exemplifying embodiment of a device 500. The control arrangement 100 described above may for example comprise the device 500, consist of the device 500, or be comprised in the device 500.

The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer program P that comprises instructions for performing a method for deactivating an adaptive cruise control system of a host vehicle, said adaptive cruise control system being configured to maintain a safe distance to a target vehicle in front of the host vehicle through usage of one or more auxiliary brake systems and a service brake system of the host vehicle. The computer program comprises instructions for, in response to a determination of risk of loss of functionality of the adaptive cruise control system while the host vehicle is, or is precited to be, decelerated by the adaptive cruise control system, determining whether the host vehicle may be braked by at least the service brake system. The computer program further comprises instructions for, when it is determined that the host vehicle may be braked by at least the service brake system, activating a first failure mode during which the adaptive cruise control system is maintained active to decelerate the host vehicle until a deceleration demand of the adaptive cruise control system is below a predetermined threshold or a difference in speed between the host vehicle and the target vehicle is below a predetermined limit. The computer program further comprises instructions for, when the deceleration demand of the adaptive cruise control system is below the predetermined threshold, or the difference in speed between the host vehicle and the target vehicle is below the predetermined limit, either (i) ramping down the braking demanded by the adaptive cruise control system over a predetermined period of time and thereafter deactivating the adaptive cruise control system, or (ii) directly deactivating the adaptive cruise control system.

The program P may be stored in an executable form or in a compressed form in a memory 560 and/or in a read/write memory 550.

The data processing unit 510 may perform one or more functions, i.e. the data processing unit 510 may effect a certain part of the program P stored in the memory 560 or a certain part of the program P stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The communication between the constituent components may be implemented by a communication link. A communication link may be a physical connection such as an optoelectronic communication line, or a non-physical connection such as a wireless connection, e.g. a radio link or microwave link.

When data are received on the data port 599, they may be stored temporarily in the second memory element 540. When input data received have been temporarily stored, the data processing unit 510 is prepared to effect code execution as described above.

1. A method, performed by a control arrangement, for deactivating an adaptive cruise control system of a host vehicle, said adaptive cruise control system being configured to maintain a safe distance to a target vehicle in front of the host vehicle through usage of one or more auxiliary brake systems and a service brake system of the host vehicle, the method comprising:
in response to a determination of risk of loss of functionality of the adaptive cruise control system while the host vehicle is, or is precited to be, decelerated by the adaptive cruise control system, determining whether the host vehicle may be braked by at least the service brake system;
in case it is determined that the host vehicle may be braked by at least the service brake system, activating a first failure mode during which the adaptive cruise control system is maintained active to decelerate the host vehicle until a deceleration demand of the adaptive cruise control system is below a predetermined threshold or a difference in speed between the host vehicle and the target vehicle is below a predetermined limit; and
when the deceleration demand of the adaptive cruise control system is below the predetermined threshold, or the difference in speed between the host vehicle and the target vehicle is below the predetermined limit, either:
ramping down the braking demanded by the adaptive cruise control system over a predetermined period of time and thereafter deactivating the adaptive cruise control system, or
directly deactivating the adaptive cruise control system.

2. The method according to claim 1, wherein said determination of risk of loss of functionality of the adaptive cruise control system is based on an assessment that the host vehicle cannot be positively accelerated by the adaptive cruise control system.

3. The method according to claim 1, further comprising:
when deactivating the adaptive cruise control system, generating a warning message and/or signal adapted to inform a driver of the host vehicle of deactivation of the adaptive cruise control system.

4. The method according to claim 1, further comprising:
in response to a determination that information pertaining to the target vehicle is lost by the adaptive cruise control system, activating a second failure mode during which braking demanded by the adaptive cruise control system is ramped down over a predetermined period of time, and
thereafter deactivating the adaptive cruise control system.

5. The method according to claim 4, further comprising:
when the second failure mode is activated, generating a warning message and/or signal adapted to inform a driver of the host vehicle of upcoming deactivation of the adaptive cruise control system.

6. The method according to claim 1, wherein the step of determining whether the host vehicle may be braked by at least the service brake system comprises determining whether the temperature of the service brake system is below a predefined temperature threshold.

7. The method according to claim 1, further comprising:
in case it is determined that the host vehicle cannot be braked by the service brake system, deactivating the adaptive cruise control system.

8. A computer program product stored on a non-transitory computer-readable medium, said computer program product for deactivating an adaptive cruise control system of a host vehicle, said adaptive cruise control system being configured to maintain a safe distance to a target vehicle in front of the host vehicle through usage of one or more auxiliary brake systems and a service brake system of the host vehicle, wherein said computer program product comprising computer instructions to cause one or more computing devices to perform the following operations:
in response to a determination of risk of loss of functionality of the adaptive cruise control system while the host vehicle is, or is precited to be, decelerated by the adaptive cruise control system, determining whether the host vehicle may be braked by at least the service brake system;
in case it is determined that the host vehicle may be braked by at least the service brake system, activating a first failure mode during which the adaptive cruise control system is maintained active to decelerate the host vehicle until a deceleration demand of the adaptive cruise control system is below a predetermined threshold or a difference in speed between the host vehicle and the target vehicle is below a predetermined limit; and
when the deceleration demand of the adaptive cruise control system is below the predetermined threshold, or the difference in speed between the host vehicle and the target vehicle is below the predetermined limit, either:
ramping down the braking demanded by the adaptive cruise control system over a predetermined period of time and thereafter deactivating the adaptive cruise control system, or
directly deactivating the adaptive cruise control system.

9. (canceled)

10. A control arrangement configured to deactivate an adaptive cruise control system of a host vehicle, said adaptive cruise control system being configured to maintain a safe distance to a target vehicle in front of the host vehicle through usage of one or more auxiliary brake systems and a service brake system of the host vehicle,
the control arrangement configured to:
in response to a determination of risk of loss of functionality of the adaptive cruise control system while the host vehicle is, or is precited to be, decelerated by the adaptive cruise control system, determine whether the host vehicle may be braked by at least the service brake system;
when having determined that the host vehicle may be braked by at least the service brake system, activate a first failure mode during which the adaptive cruise control system is maintained active to decelerate the host vehicle until a deceleration demand of the adaptive cruise control system is below a predetermined threshold or a difference in speed between the host vehicle and the target vehicle is below a predetermined limit; and
when the deceleration demand of the adaptive cruise control system is below the predetermined threshold, or the difference in speed between the host vehicle and the target vehicle is below the predetermined limit, either:
ramp down the braking demanded by the adaptive cruise control system over a predetermined period of time and thereafter deactivate the adaptive cruise control system, or
directly deactivate the adaptive cruise control system.

11. The control arrangement according to claim 10, wherein the control arrangement is configured to determine said risk of loss of functionality of the adaptive cruise control system based on an assessment that the host vehicle cannot be positively accelerated by the adaptive cruise control system.

12. The control arrangement according to claim 10, wherein the control arrangement is further configured to:
in response to a determination that information pertaining to the target vehicle is lost by the adaptive cruise control system, activate a second failure mode during which braking demanded by the adaptive cruise control system is ramped down over a predetermined period of time; and
thereafter deactivate the adaptive cruise control system.

13. A vehicle comprising a control arrangement configured to deactivate an adaptive cruise control system of a host vehicle, said adaptive cruise control system being configured to maintain a safe distance to a target vehicle in front of the host vehicle through usage of one or more auxiliary brake systems and a service brake system of the host vehicle,
the control arrangement configured to:
in response to a determination of risk of loss of functionality of the adaptive cruise control system while the host vehicle is, or is precited to be, decelerated by the adaptive cruise control system, determine whether the host vehicle may be braked by at least the service brake system;
when having determined that the host vehicle may be braked by at least the service brake system, activate a first failure mode during which the adaptive cruise control system is maintained active to decelerate the host vehicle until a deceleration demand of the adaptive cruise control system is below a predetermined threshold or a difference in speed between the host vehicle and the target vehicle is below a predetermined limit; and
when the deceleration demand of the adaptive cruise control system is below the predetermined threshold, or the difference in speed between the host vehicle and the target vehicle is below the predetermined limit, either:
ramp down the braking demanded by the adaptive cruise control system over a predetermined period of time and thereafter deactivate the adaptive cruise control system, or
directly deactivate the adaptive cruise control system.

14. The control arrangement according to claim 10, further configured to:
when deactivating the adaptive cruise control system, generate a warning message and/or signal adapted to inform a driver of the host vehicle of deactivation of the adaptive cruise control system.

15. The control arrangement according to claim 10, further configured to:
in response to a determination that information pertaining to the target vehicle is lost by the adaptive cruise control system, activate a second failure mode during which braking demanded by the adaptive cruise control system is ramped down over a predetermined period of time; and
thereafter deactivate the adaptive cruise control system.

16. The control arrangement according to claim 15, further configured to:
when the second failure mode is activated, generate a warning message and/or signal adapted to inform a driver of the host vehicle of upcoming deactivation of the adaptive cruise control system.

17. The control arrangement according to claim 10, wherein determining whether the host vehicle may be braked by at least the service brake system comprises determining whether the temperature of the service brake system is below a predefined temperature threshold.

18. The control arrangement according to claim 10, further configured to:
in case it is determined that the host vehicle cannot be braked by the service brake system, deactivate the adaptive cruise control system.
